(19) United States
(12) Patent Application Publication
(10) Pub. No.: US 2013/0138732 A1
(43) Pub. Date: May 30, 2013

(54) ACCESS TO A NETWORK OF NODES DISTRIBUTED OVER A COMMUNICATION ARCHITECTURE WITH THE AID OF A TOPOLOGY SERVER WITH MULTICRITERIA SELECTION

(71) Applicant: Claire Sabine Randriamasy, Paris (FR)

(72) Inventor: Claire Sabine Randriamasy, Paris (FR)

(73) Assignee: ALCATEL-LUCENT, Paris (FR)

(21) Appl. No.: 13/806,874

(22) PCT Filed: Jul. 5, 2011
(86) PCT No.: PCT/FR2011/051582

§ 371 Date: Feb. 6, 2013

(30) Foreign Application Priority Data
Jul. 8, 2010 (FR) 1055568

(51) Int. Cl. H04L 29/08

(52) U.S. Cl. CPC H04L 29/08315
USPC 709/203

(57) ABSTRACT

A system (CALTo, M) for accessing an application distributed across a network of nodes (N1, N2, N3 . . . N50) deployed on a communication architecture (A) by an application client (C) connected to the communication architecture, comprising a server (S) that has a topological view of the network within the communication architecture, and means for providing, upon the client's request, information about a set of nodes of the network based on said topological view, wherein the server is capable of providing information pertaining to a plurality of characteristics related to that set of nodes

The present invention relates to applications distributed across a network of nodes deployed over a communication architecture.

These applications comprise applications called “peer to peer” (or p2p) but also CDN (Content Delivery Network) networks which are made up of computers networked over the Internet, and which cooperate in order to provide content or data (generally, large multimedia content) to users.

This type of network is made up of:
origin servers, in which the content is “injected” into the CDNs to be replicated;
storage nodes (whether permanent or not) geographically distributed on Internet “edges”, in which the content is replicated;
a semantic routing mechanism (“name-based routing”) that allows a user request for a piece of content to be served by the “closest” node, in the semantic sense

These distributed applications also comprise “computing grids”, more commonly known as grids, which are virtual infrastructures made up of a set of computer resources that are potentially shared, distributed, heterogeneous, remote, and independent.

Other types of applications may also be included within the scope of the invention. These distributed applications share the same characteristic of joining application nodes into a network (“overlay”), based on their content or semantic characteristics, but without caring about the topological characteristic of the underlying communication architecture.

This independence between the logical structure and hardware architecture has advantages, but also at least one major drawback, because the deployment of the network of application nodes does not take into account that communication architecture's topology.

Rather, two nodes can be neighbors within the network of nodes based purely on application and semantic criteria, but be deployed in remote communication networks. A situation in which one node is located in one continent and its neighbor in another is not rare.

The result is not only an increase in end-to-end transmission times and a degradation in the general performance of the network of nodes, but also, owing to the use of many remote connections, a congestion of the Internet network as a whole.

Another problem is that this requires that operators allow unbilled traffic to travel through their networks. This requires some operators to add size to their networks or downgrade the quality of service assigned to that traffic.

Proposals have been made to improve the situation. One of these proposals is the “ALTO” (Application-Layer Traffic Optimization) service being studied by a workgroup within the IETF (Internet Engineering Task Force).

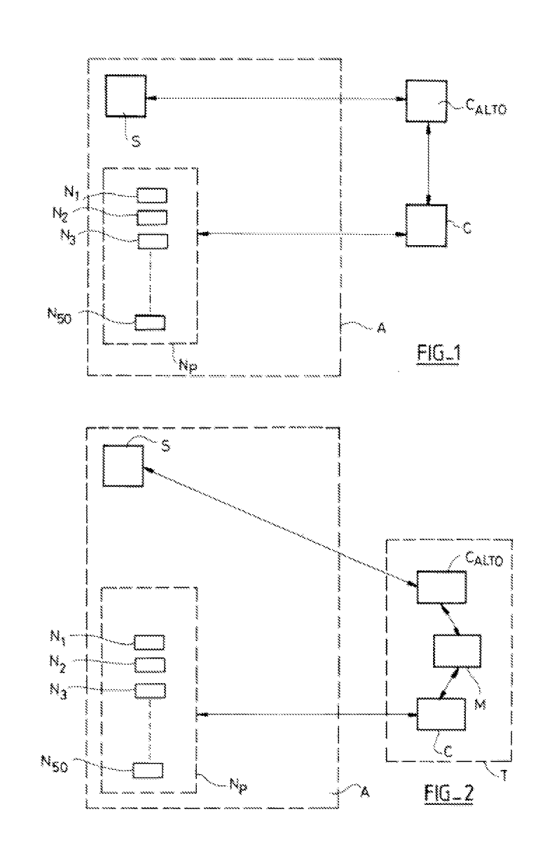

The principle of this proposal is illustrated by FIG. 1 and relies on a server S that has a partial view of the communication architecture A. This ALTO server S allows ALTO clients C_{ALTO} to obtain information about a set of nodes N1, N2, N3 . . . N50 of the network of nodes Np that takes into account this partial view. This view is partial in the sense that it only covers one region of the communication architecture, and it is centered on the operator of a given independent system whose view of the Internet network it represents.

As described in section 2.2 of the document draft-ietf-alto-protocol-04.txt, a region may be an independent system, a network managed by an Internet service provider (ISP), or a subnetwork or set of such networks.

The ALTO server S may offer different services to ALTO clients. It may particularly provide a map of its view of the network or provide a sequence of a set of nodes whose identifiers are transmitted to it by the ALTO client to which the application client C is connected.

This information provided by the server S takes into account the network's topology and can therefore allow clients C to set up a network of nodes (particularly a peer-to-peer network) benefiting from that knowledge. Thus, optimal networks for the transmission/delivery mechanism may be put in place.

However, this mechanism only makes it possible to determine information related to a single characteristic at a time, is currently specified by the document draft-ietf-alto-protocol-04.txt. According to section 5.1.1, this characteristic may be a geographic distance, a number of hops, or a generic routing code.

In its request to the ALTO server, the client must specify a characteristic (known as a “Cost Type”), and the server responds with information about that characteristic.

However, it may be beneficial to not rely upon a single characteristic, but rather to allow a set of application nodes to be chosen from a plurality of characteristics. It may also be beneficial to take into account a greater diversity of characteristics, and thereby to allow a large number of combinations and choice criteria.

This is currently only possible by sending as many requests to the ALTO server as characteristics to be taken into account. The client may then combine the received information in order to build its solution. Nonetheless, such a procedure is not optimal. This is because it generates a large number of messages between the ALTO client and server. This traffic is not billable for the operator, and may contribute to congesting the communication architecture's resources.

Furthermore, the IETF's RFC 5693 formalizing the ALTO problem states in its section 5.1 “Information Provided by an ALTO Service”, that the information provided by the ALTO service is characterized by infrequent changes, as information that frequently changes would require frequent and costly updates or else would often be obsolete. This is true of metrics that reflect the state of the network at a given moment, such as end-to-end time or available bandwidth. However, there are currently many successful applications whose good working order relies on knowing the statistical values of these metrics. Service and network operators, and application nodes as well, increasingly calculate and store these statistics in order to better manage traffic. It is therefore disappointing that these statistics cannot be integrated into the services provided by ALTO, given that they often already exist and cover time range is compatible with the frequency of ALTO server updates.

There is therefore a real need to improve the situation.

To do so, invention discloses a system for accessing an application distributed across a network of nodes deployed on a communication architecture, by an application client connected to that communication architecture. The access system comprises a server that has a topological view of the network within the communication architecture and means for providing, upon the application client's request, information about a set of that network's nodes based on the topological view.

The server is capable of providing information about a plurality of characteristics related to that set of nodes.

According to one embodiment of the invention, the access system further comprises a mediation device operative to determine a sequence of the nodes in the set of nodes based on that information.

The mediation device may be operative to determine the sequence based on weights associated with said characteristics.

These weights may be provided by said application client.

The information may be in the form of a vector of scalar values.

The sequencing may be performed based on a distance to an ideal vector.

The inventive access system may be implemented on a communication terminal that also implements the application client.

A further object of the invention is a method for accessing an application distributed across a network of nodes deployed on a communication architecture by an application client connected to the communication architecture, comprising the transmission by a server that has a topological view of the network within the communication architecture, to the application client, of information about a set of nodes of the network based on that topological view, wherein the information pertains to a plurality of characteristics related to the set of nodes.

A further object of the invention is a software application comprising means operative to carry out this method when it is implemented on a data processing device.

The invention, its advantages and its characteristics will appear more clearly in the description of embodiments which follows, together with the attached figures.

FIG. 1, already mentioned, depicts a communication architecture that implements the ALTO protocol.

FIG. 2 diagrams a communication architecture that implements and access system according to the invention.

The view depicted in FIG. 2 is a schematic functional view. It has been intentionally simplified in order to make the invention's principles easier to explain.

It represents a communication architecture A to which a client C is connected. This client C is an application client that wishes to use an application distributed across nodes N1, N2, N3 . . . N50 of a network of nodes Np.

As mentioned above, these nodes have different characteristics, particularly with respect to the topology of the network. Thus, they may be located on equipment connected to the communication architecture A by different access means (Ethernet, Wifi, 3G, LTE, etc.), each having different characteristics in terms of bandwidth, uptime, etc. but they may also be located within different operators' networks, and in very different geographical areas.

The application client C may be located on a telecommunication terminal T. It may be a mobile telephone, a laptop computer, a personal digital assistant, or any other device that enables the user to connect to applications located on a communication architecture, such as the Internet. The applications may be networked gaming applications, filesharing applications, multimedia flow access applications, particularly for videos, shared computing applications, etc.

In a manner known per se, the application client C may recognize a list of nodes of the network Np. Different techniques exist to do so, such as for example, the use of a centralized server that offers an access point to that network. This centralized server is, for example, a “tracker” within the context of a “peer-to-peer” network Np. In a completely distributed mode, the peer nodes may be identified by peer exchange (PEX) techniques, or by a search engine.

The application client C may then transmit that list to the ALTO client CALTO in the form of a service request. This ALTO client may be co-located within the communication terminal T, as depicted by FIG. 2. In such a case, there are two functional modules that may be distinct (two different software products operating with one another through interfaces) or technical means assembled into a single software module.

It may also be located within the communication architecture A, for example within the centralized server identifying the nodes of the network Np (tracker, etc . . . ) mentioned above.

The ALTO client is a functional entity adapted to ensure the interface between an application client C and an ALTO server. It particularly implements the software means that enable communication with the server in accordance with the ALTO protocol currently being specified by the IETF. It may further comprise the means for determining which ALTO servers are available within the communication architecture A to which it is connected, as well as the services that they provide.

The ALTO client C_{ALTO} then transmits a service request to an ALTO server S. This service request comprises the list of nodes determined by the application client C, as well as an identifier of a service. This service may comprise the services defined in section 3.2 of the document draft-ieff-alto-protocol-04.txt mentioned above, but it may obviously comprise others, whether standardized or proprietary. The services currently taken into account by the ALTO protocol that is undergoing specification are “Map Service”, “Map Filtering Service”, “Endpoint Property Service”, and “Endpoint Cost Service”.

Furthermore, the request may contain a set of characteristics. These characteristics may be provided by the application client C, as choosing which ones depends on the application, but it may be foreseen that the ALTO client or a third-party functional module may determine or contribute to the determination of those characteristics based on other data.

According to one embodiment of the invention, the client C transmits the request to the ALTO client by means of a mediation device M.

The application client C transmits to the ALTO client CANTO the identifiers of a set of nodes.

The application client C also transmits a request to the mediation device M.

This request contains:
A number of nodes, whose sequence and/or cost the client C wants to know.
A plurality of characteristics,
and potentially weights associated with those characteristics.

It is also possible to put into the request multiple groups comprising associations between characteristics, weights, and number of nodes desired.

When the request is received, the mediation device M transmits a second request to the ALTO client C_{ALTO}.

This second request contains the plurality of characteristics.

The ALTO client then transmits a request in accordance with the ALTO specifications to the ALTO server, which comprises
a parameter that indicates that it wants a vector regarding a set of characteristics in response,
the plurality of characteristics, and
the identifiers of the set of nodes.

It may also need to comprise a parameter specifying that the returned parameter values are scalar, not ordinal values.

The ALTO server uses the topological view that it has in order to determine information about the plurality of characteristics received regarding the set of nodes whose information it has received. It sends back to the ALTO client C_{ALTO} a vector containing those parameters. Its reply may schematically have the format:
N1, V1C1, V1C2, V1C3, V1C4;
N2, V2C1, V2C2, V2C3, V2C4;
N5, V5C1, V5C2, V5C3, V5C4;
   in which Ni indicates the identifier of the node x and ViCj represents the value for node i of characteristic j.

These characteristics q result from the topology of the network Np within the communication architecture A. They comprise characteristics about the connections between equipment (number of IP hops, cost of each IP hop as a generic value or air kilometres, for instance) and characteristics about the application nodes themselves (identity assigned by the ALTO service, type of connectivity, memory or CPU time resources available, etc.).

The cost of each IP hop may take into account different criteria that may form part of the topological view that the ALTO server has S: bandwidth, transmission time, jitter, congestion of an IP equipment, etc.

This data may be periodically measured and updated within the ALTO server S; it may be provided by network management tools. Data options compatible with RFC 5693 may be:
statistics about the network's highly dynamic state metrics,
an indicator, for example a scalar one, for each metric, of node quality according to that metric,
potentially a reliability indicator for each piece of information (statistics or indications)
the time range, for example the hours that apply for those values,
potentially for each metric, a set comprising given time ranges and the values of the statistics or indicators mentioned below.

However, the processes are outside the scope of the invention itself, and will not be described further.

The response from the ALTO server S may be sent back to the ALTO client C_{ALTO} according to the ALTO protocol currently undergoing specification. This response is retransmitted to the mediation device M.

That device may implement various optimization techniques to seek out the best characteristics vectors based on the weights provided by the application client C.

It may be beneficial to seek to optimize a characteristics vector rather than each of the characteristics taken separately. The solutions discovered are more stable and sensible from a physical viewpoint. A Pareto-optimal point may be obtained, meaning a vector in which at least one component is not surpassed by that component in any other vector.

The mediation device may perform a sequencing of the nodes based on this information sent back by the ALTO server S. This sequence may be based on a distance between the vectors associated with each node in the set and an ideal vector.

This ideal vector may be the one in which each component is the best value observed from among the extracted efficient (or Pareto-optimal) solutions.

The mediation device M may then return these results to the application client. If the application client, in its initial request, transmitted a number of nodes that it wants to connect to, only that number of nodes will be returned.

The response may consist of a list of node identifiers thereby determined, potentially associated with a value. This value may be the associated characteristics vector as communicated by the ALTO server S, or a more integrated value, which may be an ordinal representative of the distance between that vector and an ideal vector.

The choice of a value type may be determined by a parameter transmitted in the request from the application client C to the mediation device M.

The application client may establish communication with the chosen nodes in a way known per se. However, those nodes have been optimally chosen according to characteristics determined by the application. Furthermore, to achieve these ends, the additional traffic was not increased, because a single request to the ALTO server had been sent and the additional traffic between application client, ALTO client, and mediation device is very limited, and may be local within the communication terminal itself and therefore come at no cost to the communication architecture A.

1) A system for accessing an application distributed across a network of nodes deployed on a communication architecture by an application client connected to said communication architecture, comprising a server that has a topological view of said network within said communication architecture, in accordance with the ALTO standard, and means for providing, upon said client's request, information about a set of nodes of said network based on said topological view, wherein said server is capable of providing information pertaining to a plurality of characteristics related to said set of nodes

2) An access system according to claim 1, further comprising a mediation device operative to determine a sequence of the nodes of said set of nodes based on said information.

3) An access system according to claim 2, wherein said mediation device is operative to determine said sequence based on weights associated with said characteristics.

4) An access system according to claim 3, wherein said weights are provided by said application client.

5) An access system according to claim 1, operative to be implemented on a communication terminal also implementing said application client.

6) An access system according to claim 1, in which said information is in the form of a vector of scalar values.

7) An access system according to claim 6, wherein said sequence is performed based on a distance to an ideal vector.

8) A method for accessing an application distributed across a network of nodes deployed on a communication architecture by an application client connected to said communication architecture, comprising the transmission by a server that has a topological view of said network within said communication architecture, in accordance with the ALTO standard, to said application client, information about a set of nodes of said network based on said topological view, wherein said information pertains to a plurality of characteristics related to said set of nodes

9) A computer program comprising means for executing the steps of the method according to claim 8 whenever said program is executed on a data processing device.
